(19) United States
(12) Patent Application Publication
(10) Pub. No.: US 2007/0177625 A1
(43) Pub. Date: Aug. 2, 2007

(54) Packet communication system, packet communication method, transmission apparatus, and storage medium having stored therein computer program

(75) Inventors: Masanobu Morinaga, Kawasaki (JP); Noriyuki Fukuyama, Kawasaki (JP); Hideaki Miyazaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/495,548

(22) Filed: Jul. 31, 2006

(30) Foreign Application Priority Data
Jan. 30, 2006 (JP) 2006-021472

(51) Int. Cl. H04J 3/22

(52) U.S. Cl. 370/468; 370/352

(57) ABSTRACT

The invention provides a packet communication system, a packet communication method, a transmission apparatus, and a storage medium having stored therein a computer program used in the transmission apparatus. The transmission apparatus generates a random number, sets a packet transmission interval based on the generated random number, and transmits a packet in the packet transmission interval. In addition, the transmission apparatus transmits a load density detection packet for detecting traffic load density, receives from a reception apparatus transmission quality information about the delay and/or loss rate of the load density detection packet, and calculates, based on the received transmission quality information, a time at which delay is smallest in a packet transmission interval and/or a time at which a loss rate is lowest in the packet transmission interval. The transmission apparatus sets the calculated time as a packet transmission start time and starts packet transmission.

### CROSS-REFERENCE TO RELATED APPLICATIONS

This Nonprovisional application claims priority under 35 U.S.C. §119(a) on Patent Application No. 2006-021472 filed in Japan on Jan. 30, 2006, the entire contents of which are hereby incorporated by reference.

### BACKGROUND OF THE INVENTION

1. Field of the Invention

The present invention relates to a packet communication system that establishes a connection to a communication network to transmit a packet, a packet communication method, a transmission apparatus, and a computer program. In particular, the present invention relates to a packet communication system which allows to improve the transmission quality (QoS: Quality of Service) of a real-time system such as VoIP and video streaming, a packet communication method, a transmission apparatus, and a storage medium having stored therein a computer program.

2. Description of the Background Art

In recent years, the use of an application of a real-time system, such as VoIP (Voice Over Internet Protocol) and video streaming, in which the transmission and reception of data such as audio and video are transmitted between apparatuses through a communication network, has increased. When a real-time system application is used, playback quality upon reproduction of data, such as audio and video, received by the application is affected by the conditions of a communication network. Thus, when a real-time system application is newly introduced, in order to further improve the playback quality, the conditions of the communication network need to be grasped.

However, a VoIP call is made between the same locations, and moreover, even if there are a plurality of calls which use the same path, conversational quality may vary due to varying levels of a traffic load of the call path. This occurs because a high amount of traffic having a predetermined period is superimposed on the transmission interval of VoIP packets, periodic bias occurs in traffic load density. When the transmission interval of VoIP packets corresponds to a period at which the load density is high, it is highly possible that delay or packet loss occurs; consequently, it becomes difficult to maintain conversational quality at a high level.

In view of this, for example, Japanese Laid-Open Patent Publications No. 2003-046563 and No. 2005-252665 disclose a VoIP audio packet transmission method in which by changing the transmission interval of packets, an audio CODEC, etc., the transmission interval is changed in conjunction with a transmission size. By performing control such that the transmission interval of audio packets corresponds to a period with as low load density as possible, conversational quality can be maintained at a high level.

### BRIEF SUMMARY OF THE INVENTION

The present invention is made in view of the foregoing and other problems. An object of the present invention is therefore to provide a packet communication system capable of improving transmission quality only by controlling a packet transmission interval on the transmission apparatus side, a packet communication method, a transmission apparatus, and a storage medium having stored therein a computer program used in the transmission apparatus.

Another object of the present invention is to provide a packet communication system capable of transmitting a transmission packet at a transmission time period at which traffic is low by obtaining density distribution of a traffic load in a transmission interval of transmission packets by transmitting a load detection packet, or by obtaining the density distribution from an external detecting apparatus, a packet communication method, a transmission apparatus, and a storage medium having stored therein a computer program used in the transmission apparatus. Note that the density distribution of the traffic load is meant to be fluctuations in the amount of the traffic load against time change. The density distribution of the traffic load may have extreme bias due to periodic fluctuations in traffic load.

To achieve the aforementioned objects, a first aspect of the present invention is directed to a packet communication system comprising: a transmission apparatus that establishes a connection to a communication network to transmit a packet, wherein the transmission apparatus comprises: random number generating means for generating a random number; and interval setting means for setting a packet transmission interval based on the generated random number, in which the packet is transmitted in the packet transmission interval.

A second aspect of the present invention is directed to a packet communication system comprising: a transmission apparatus that establishes a connection to a communication network to transmit a packet; and a reception apparatus that establishes a connection to the communication network to receive the packet, wherein the transmission apparatus comprises: means for calculating, based on transmission quality information about transmission quality which is returned in response to the transmitted packet, timing at which delay is smallest in a packet transmission interval and/or timing at which a loss rate is lowest in the packet transmission interval; transmission start time setting means for setting a packet transmission start time with the calculated timing; and means for starting packet transmission at the packet transmission start time.

A third aspect of the present invention is directed to a packet communication system comprising: a transmission apparatus that establishes a connection to a communication network to transmit a packet; and a traffic load density detecting apparatus that establishes a connection to the communication network to transmit and receive a load density detection packet for detecting traffic load density, thereby detecting the traffic load density, wherein the transmission apparatus comprises: means for receiving from the traffic load density detecting apparatus transmission quality information which includes timing at which delay is smallest based on the detected load density and/or timing at which a loss rate is lowest based on the detected load density; transmission start time setting means for setting a packet transmission start time with the received timing; and means for starting packet transmission at the packet transmission start time.

A fourth aspect of the present invention is directed to a packet communication method using a transmission apparatus that establishes a connection to a communication network to transmit a packet, wherein the transmission apparatus generates a random number, sets a packet transmission interval based on the generated random number, and transmits the packet in the packet transmission interval.

A fifth aspect of the present invention is directed to a packet communication method using a transmission apparatus that establishes a connection to a communication network to transmit a packet, and a reception apparatus that establishes a connection to the communication network to receive the packet, wherein the transmission apparatus calculates, based on transmission quality information about transmission quality which is returned in response to the transmitted packet, timing at which delay is smallest in a packet transmission interval and/or timing at which a loss rate is lowest in the packet transmission interval, sets a packet transmission start time with the calculated timing, and starts packet transmission at the packet transmission start time.

A sixth aspect of the present invention is directed to a packet communication method using a transmission apparatus that establishes a connection to a communication network to transmit a packet, and a traffic load density detecting apparatus that establishes a connection to the communication network to transmit and receive a load density detection packet for detecting traffic load density, thereby detecting the traffic load density, wherein the transmission apparatus receives from the traffic load density detecting apparatus transmission quality information which includes timing at which delay is smallest based on the detected load density and/or timing at which a loss rate is lowest based on the detected load density, sets a packet transmission start time with the received timing, and starts packet transmission at the packet transmission start time.

A seventh aspect of the present invention is directed to a transmission apparatus that establishes a connection to a communication network to transmit a packet, the transmission apparatus comprising: random number generating means for generating a random number; and interval setting means for setting a packet transmission interval based on the generated random number, wherein the packet is transmitted in the packet transmission interval.

An eighth aspect of the present invention is directed to a transmission apparatus that establishes a connection to a communication network to transmit a packet, the transmission apparatus comprising: means for calculating, based on transmission quality information about transmission quality which is returned in response to the transmitted packet, timing at which delay is smallest in a packet transmission interval and/or timing at which a loss rate is lowest in the packet transmission interval; transmission start time setting means for setting a packet transmission start time with the calculated timing; and means for starting packet transmission at the packet transmission start time.

A ninth aspect of the present invention is directed to a storage medium having stored therein a computer program executable by a transmission apparatus that establishes a connection to a communication network to transmit a packet, the computer program causing the transmission apparatus: to generate a random number; an interval setting unit that sets a packet transmission interval based on the generated random number; and to transmit the packet in the packet transmission interval.

A tenth aspect of the present invention is directed to a storage medium having stored therein a computer program executable by a transmission apparatus that establishes a connection to a communication network to transmit a packet, the computer program causing the transmission apparatus: to calculate, based on transmission quality information about transmission quality which is returned in response to the transmitted packet, timing at which delay is smallest in a packet transmission interval and/or timing at which a loss rate is lowest in the packet transmission interval; to set a packet transmission start time with the calculated timing; and to start packet transmission at the packet transmission start time.

In the first, fourth, seventh, and ninth aspects, a transmission apparatus that establishes a connection to a communication network to transmit a packet is used. The transmission apparatus generates a random number, sets a packet transmission interval based on the generated random number, and transmits the packet in the packet transmission interval. By this, the transmission timing randomly changes, whereby the distribution of a traffic load is leveled; as a result, packet loss is reduced and the occurrence of delay is reduced. Accordingly, transmission quality difference caused by different transmission timing can be reduced, making it possible to improve transmission quality.

In the second, fifth, eighth, and tenth aspects, a transmission apparatus that establishes a connection to a communication network to transmit a packet and a reception apparatus that establishes a connection to the communication network to receive the packet are used. The transmission apparatus calculates, based on transmission quality information about transmission quality which is returned in response to the transmitted packet, timing at which delay is smallest in a packet transmission interval and/or timing at which a loss rate is lowest in the packet transmission interval, sets a packet transmission start time with the calculated timing, and starts packet transmission at the packet transmission start time. By this, based on the transmission quality information returned from the reception apparatus in response to the packet transmitted from the transmission apparatus, density distribution of a traffic load in a predetermined transmission interval, e.g., a transmission interval of VoIP packets, can be calculated. Then, by setting transmission timing such that a packet is transmitted at timing with low traffic load density, transmission quality can be maintained at a high level.

In the third, sixth, eighth, and tenth aspects, a transmission apparatus that establishes a connection to a communication network to transmit a packet, and a traffic load density detecting apparatus that establishes a connection to the communication network to transmit and receive a load density detection packet for detecting traffic load density, thereby detecting the traffic load density are used. The transmission apparatus receives from the traffic load density detecting apparatus transmission quality information which includes timing at which delay is smallest based on the detected load density and/or timing at which a loss rate is lowest based on the detected load density, sets a packet transmission start time with the received timing, and starts packet transmission at the packet transmission start time. By this, by an external load density detecting apparatus transmitting a load density detection packet, transmission quality information about packet delay and/or loss rate is obtained. The transmission apparatus receives transmission quality information from an external load density detecting apparatus and is thereby capable of calculating density distribution of a traffic load in a predetermined transmission interval, e.g., a transmission interval of VoIP packets. Then, the transmission apparatus sets transmission timing such that a packet is transmitted at timing with low traffic load density, whereby transmission quality can be maintained at a high level.

According to the first, fourth, seventh, and ninth aspects, by transmission timing randomly changing, the distribution of a traffic load is leveled; as a result, packet loss is reduced and the occurrence of delay is reduced. Accordingly, transmission quality difference caused by different transmission timing can be reduced, making it possible to improve transmission quality.

According to the second, fifth, eighth, and tenth aspects, by the transmission apparatus transmitting a load density detection packet, density distribution of a traffic load in a predetermined transmission interval, e.g., a transmission interval of VoIP packets, can be calculated. Then, by setting transmission timing such that a packet is transmitted at timing with low traffic load density, transmission quality can be maintained at a high level.

According to the third, sixth, eighth, and tenth aspects, by an external load density detecting apparatus transmitting a load density detection packet, transmission quality information about packet delay and/or loss rate is obtained. The transmission apparatus receives transmission quality information from an external load density detecting apparatus and is thereby capable of calculating density distribution of a traffic load in a predetermined transmission interval, e.g., a transmission interval of VoIP packets. Then, the transmission apparatus sets transmission timing such that a packet is transmitted at timing with low traffic load density, whereby transmission quality can be maintained at a high level.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing a configuration of a packet communication system according to a first embodiment of the present invention;

FIG. 2 is a block diagram showing a configuration of a transmission apparatus used in the packet communication system according to the first embodiment of the present invention;

FIG. 3 is a block diagram showing a configuration of a reception apparatus used in the packet communication system according to the first embodiment of the present invention;

FIG. 4 is a diagram showing packet transmission timing in a conventional packet communication method;

FIG. 5 is a diagram showing packet transmission timing in a packet communication method according to the first embodiment of the present invention;

FIG. 6 is an exemplary diagram of a configuration of an RR packet specified by RTCP;

FIG. 7 is a flowchart showing processing steps of a control unit of the transmission apparatus used in the packet communication system according to the first embodiment of the present invention;

FIG. 8 is a flowchart showing steps of a VoIP packet transmission process of a control unit of a transmission apparatus used in a packet communication system according to a second embodiment of the present invention;

FIG. 9 is a diagram showing packet transmission timing in a packet communication method according to the second embodiment of the present invention; and

FIG. 10 is a block diagram showing a configuration of a packet communication system in which traffic load density detecting apparatuses are separately provided.

### DETAILED DESCRIPTION OF THE INVENTION

In the VoIP audio packet transmission method disclosed in the aforementioned Japanese Laid-Open Patent Publication No. 2003-046563, call control needs to be performed between a transmission apparatus and a reception apparatus and the settings on the reception apparatus need to be changed according to a transmission interval of packets which is changed by the transmission apparatus and a packet size which is changed in conjunction with the transmission interval; thus, there is a problem that communication control becomes complicated.

In the VoIP audio packet transmission method disclosed in Japanese Laid-Open Patent Publication No. 2005-252665, when a transmission interval of audio packets is changed, in order to establish a call connection to the reception apparatus side, there is a need to change call control settings on a reception apparatus and then transmit audio packets in the changed transmission interval. Hence, a communication environment needs to be set in conjunction not only with a transmission apparatus but also with the reception apparatus and thus there is a problem that control becomes complicated.

The present invention is made in view of the foregoing and other problems. An object of the present invention is therefore to provide a packet communication system capable of improving transmission quality only by controlling a packet transmission interval on the transmission apparatus side, a packet communication method, a transmission apparatus, and a storage medium having stored therein a computer program used in the transmission apparatus.

Another object of the present invention is to provide a packet communication system capable of transmitting a transmission packet at a transmission time period at which traffic is low by obtaining density distribution of a traffic load in a transmission interval of transmission packets by transmitting a load detection packet, or by obtaining the density distribution from an external detecting apparatus, a packet communication method, a transmission apparatus, and a storage medium having stored therein a computer program used in the transmission apparatus. The present invention will be described in detail below based on the drawings showing embodiments of the invention.

### First Embodiment

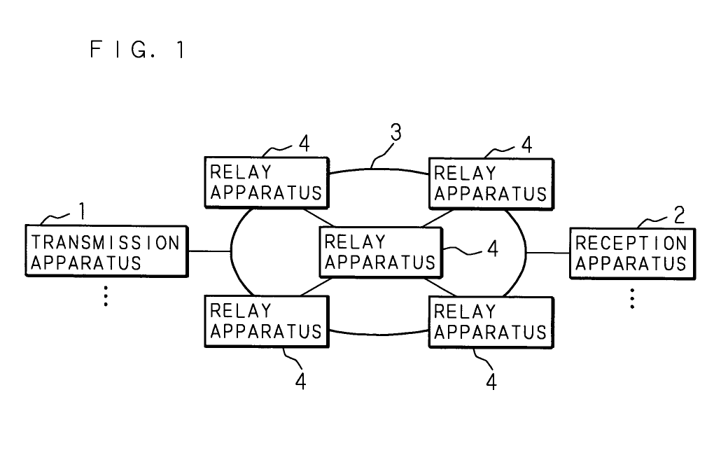

FIG. 1 is a block diagram showing a configuration of a packet communication system according to a first embodiment of the present invention. In FIG. 1, a transmission apparatus 1 is connected to a communication network 3, such as the Internet, and transmits a packet to a reception apparatus 2 which is connected to the communication network 3 as well. To the communication network 3, are connected a plurality of the transmission apparatuses 1, 1 . . . which use computers that distribute stream data such as moving images and audio, and a plurality of the reception apparatuses 2, 2 . . . that receive the stream data transmitted from the transmission apparatuses 1, 1 . . . . The communication network 3 has a plurality of relay apparatuses 4, 4 . . . such as Internet routers. Packets are transmitted to the reception apparatuses 2, 2 . . . from the transmission apparatuses 1, 1 . . . through communication paths composed of unspecified relay apparatuses 4, 4 . . . .

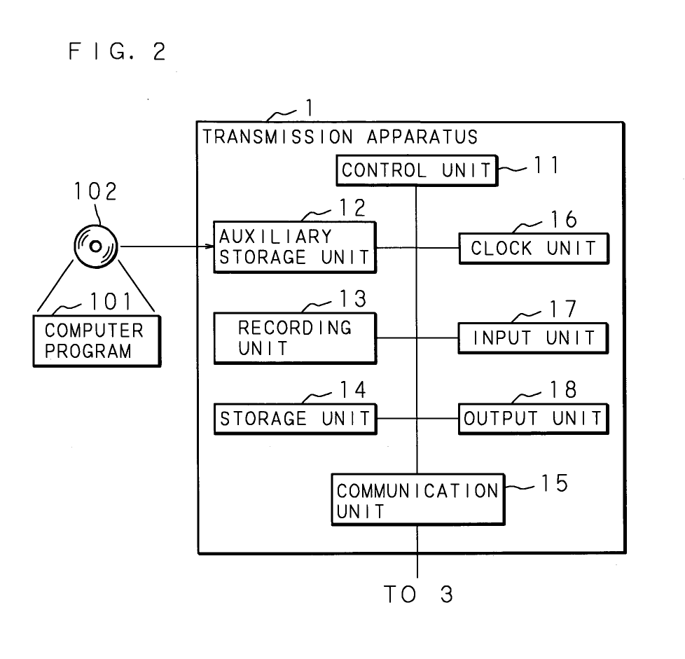

FIG. 2 is a block diagram showing a configuration of the transmission apparatus 1 used in the packet communication system according to the first embodiment of the present invention. The transmission apparatus 1 includes a control unit 11, such as a CPU, that control the entire apparatus; an auxiliary storage unit 12, such as a CD-ROM drive, that reads various information from a storage medium 102, such as a CD-ROM, having stored therein various information such as a computer program 101 executable by the transmission apparatus 1 according to the first embodiment of the present invention and data; and a recording unit 13, such as a hard disk, that records the various information read by the auxiliary storage unit 12. A computer reads from the recording unit 13 various information such as the computer program 101 according to the present invention and data, stores the information in a storage unit 14, such as a RAM, that temporarily stores information, and allows the control unit 11 to perform various steps included in the computer program 101, thereby operating as the transmission apparatus 1 according to the present invention. The transmission apparatus 1 further includes a communication unit 15 that transmits a packet; a clock unit 16 that obtains a time; an input unit 17 such as a mouse and a keyboard; and an output unit 18 such as a monitor. Note that the first embodiment is based on the assumption of an IP phone system that allows a user to make calls using a PC. It is also possible to use a dedicated terminal such as an IP telephone. In that case, needless to say, the terminal does not include a CD-ROM, the auxiliary storage unit 12 such as a CD-ROM drive, and an input unit 17 that is not provided with phone functions such as a mouse and a keyboard.

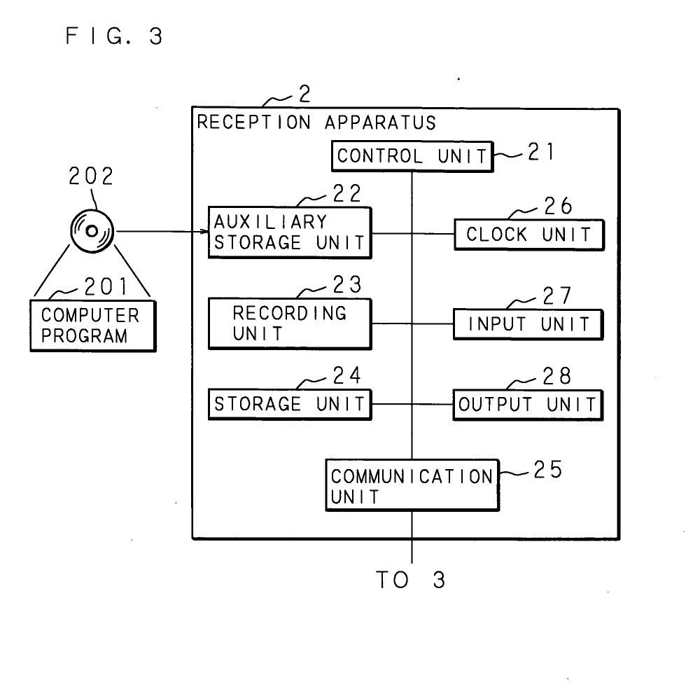

FIG. 3 is a block diagram showing a configuration of the reception apparatus 2 used in the packet communication system according to the first embodiment of the present invention. The reception apparatus 2 includes a control unit 21, such as a CPU, that controls the entire apparatus; an auxiliary storage unit 22, such as a CD-ROM drive, that reads various information from a storage medium 202, such as a CD-ROM, having stored therein various information such as a computer program 201 executable by the reception apparatus 2 according to the first embodiment of the present invention and data; and a recording unit 23, such as a hard disk, that records the various information read by the auxiliary storage unit 22. A computer reads from the recording unit 23 various information such as the computer program 201 according to the present invention and data, stores the information in a storage unit 24, such as a RAM, that temporarily stores information, and allows the control unit 21 to perform various steps included in the computer program 201, thereby operating as the reception apparatus 2 according to the present invention. The reception apparatus 2 further includes a communication unit 25 that receives a packet; a clock unit 26 that obtains a time; an input unit 27 such as a mouse and a keyboard; and an output unit 28 such as a monitor. Note that the first embodiment is based on the assumption of an IP phone system that allows a user to make calls using a PC. It is also possible to use a dedicated terminal such as an IP telephone. In that case, needless to say, the terminal does not include a CD-ROM, the auxiliary storage unit 22 such as a CD-ROM drive, and an input unit 27 that is not provided with phone functions such as a mouse and a keyboard.

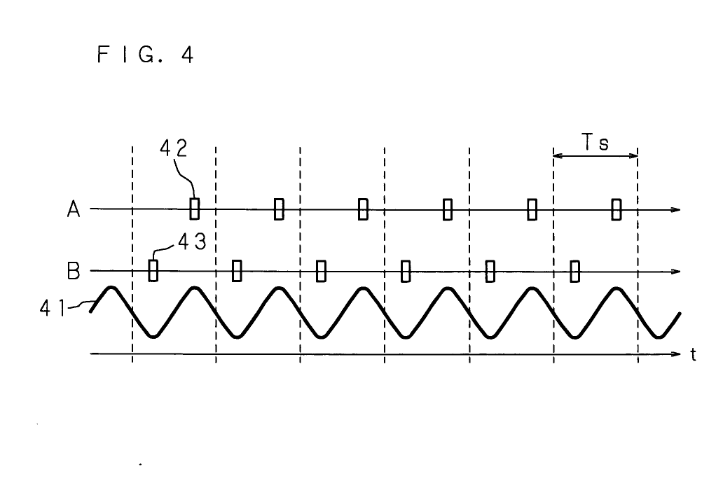

A packet communication method using the transmission apparatus 1 and the reception apparatus 2 which are configured as described above will be described. FIG. 4 is a diagram showing packet transmission timing in a conventional packet communication method. Given that, in the following description, a transmission interval Ts of VoIP packets is 20 milliseconds. Note that the transmission interval Ts is not limited to 20 milliseconds.

For example, in a call A, a VoIP packet (audio packet) 42 is always transmitted at timing which is the second half part of the transmission interval Ts of the VoIP packets. On the other hand, for example, in a call B, a VoIP packet (audio packet) 43 is always transmitted at timing which is the first half part of the transmission interval Ts of the VoIP packets. When there are more calls with transmission timing such as the one for the call A, communication traffic increases at timing which is the second half part of the transmission interval Ts of the VoIP packets, causing periodic bias in a traffic load 41. The period of the bias in the traffic load 41 is equal to the transmission interval Ts of the VoIP packets. Thus, when the VoIP packet 42 is transmitted at transmission timing such as that for the call A, it is highly possible that the VoIP packet 42 is delayed or the VoIP packet 42 is lost, resulting in degradation of conversational quality.

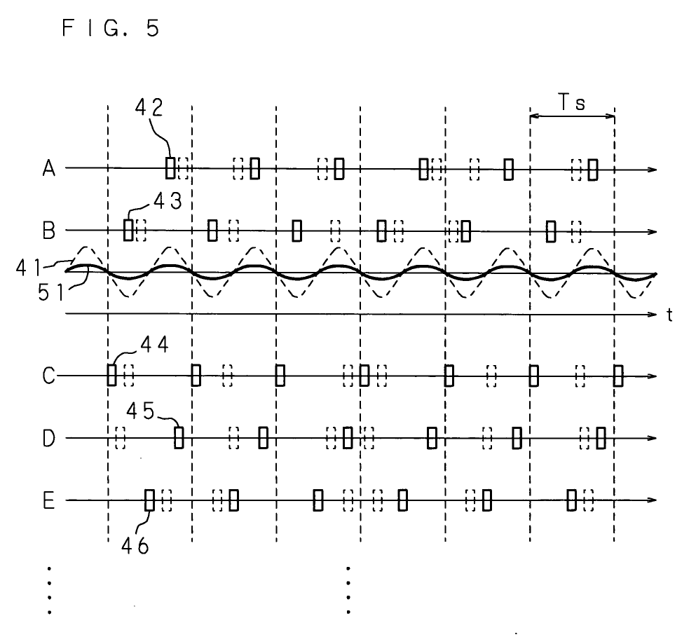

In view of this, in the first embodiment, by randomly changing the transmission intervals of VoIP packets in a plurality of calls, periodic bias which occurs in the traffic load 41 is leveled and the traffic load is reduced. FIG. 5 is a diagram showing packet transmission timing in the packet communication method according to the first embodiment of the present invention.

As shown in FIG. 5, by changing the transmission timing of VoIP packets in a plurality of calls by allowing transmission intervals to randomly fluctuate by generating random numbers, for example, VoIP packets 42, 43, 44, 45, and 46 (solid line portions) of calls A, B, C, D, E . . . are transmitted at different transmission timing (broken line portions). Since the transmission intervals Ts of the respective VoIP packets fluctuate according to the random numbers, a traffic load distribution 51 has less bias than the normal traffic load 41. In addition, whatever transmission timing a VoIP packet is transmitted, traffic is substantially uniform and thus fluctuations in conversational quality can be suppressed.

Note that for a VoIP packet to be transmitted to the reception apparatus 2 from the transmission apparatus 1, a packet specified by a communication protocol, such as RTP, for transmitting and receiving audio and moving images in real time is used.

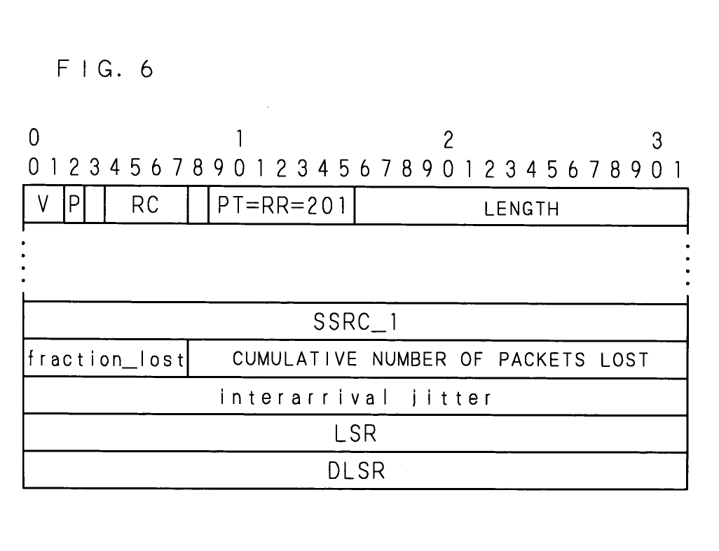

FIG. 6 is an exemplary diagram of a configuration of an RR (Receiver Report) packet specified by a report packet RTCP (RTP Control Protocol) and received as information such as a VoIP packet loss rate which is transmission quality. In RTCP, header information is included in a data field of an IP packet. In the header information, various information about a packet specified by RTCP is written. The meaning of the written information will be described below.

V (version) represents the RTCP version. P (padding) represents whether padding data for adjusting packet length is present. RC (reception report count) represents the number of blocks in a received report. PT (packet type) represents the type of an RTCP packet; in the case of an RR packet, the PT is set to “201”. SSRC_{—}1 represents the first SSRC identifier and is used to identify the transmission source of an SR packet. Fraction_lost represents the location where part of RTP packets is lost. Cumulative number of packets lost represents a cumulative value of the number of packets lost. Interarrival jitter represents an evaluation value of jitter during a response time of an RTP packet. LSR (last SR timestamp) represents a time stamp of the last RTCP packet received. DLSR (delay since last SR) represents a delay of the last RTCP packet received.

The format and contents of a report packet may be those other than those of an RTCP RR packet as long as the other format and contents allow to obtain information necessary to grasp communication conditions from a predetermined location of a packet.

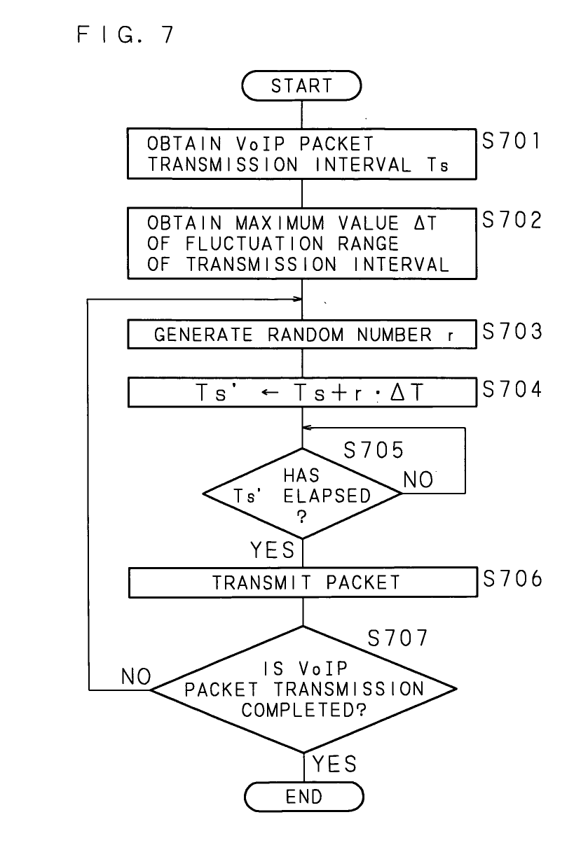

FIG. 7 is a flowchart showing processing steps of the control unit 11 of the transmission apparatus 1 used in the packet communication system according to the first embodiment of the present invention. The control unit 11 of the transmission apparatus 1 obtains a transmission interval Ts of VoIP packets (step S701). The transmission interval Ts of the VoIP packets may be received through the input unit 17 of the transmission apparatus 1 or may be received from an external apparatus through the communication unit 15.

The control unit 11 obtains a maximum value ΔT of a fluctuation range of the transmission interval of the VoIP packets by a random number (step S702). The maximum value ΔT of the fluctuation range of the transmission interval of the VoIP packets may be received through the input unit 17 of the transmission apparatus 1 or may be received from an external apparatus through the communication unit 15. Note that it is desirable that the maximum value ΔT of the fluctuation range of the transmission interval of the VoIP packets be less than the transmission interval Ts of the VoIP packets, when a random number r is 0≦r≦1 which will be described later. By doing so, packet transmission start timing can be distributed substantially uniformly within a range of the transmission interval Ts of the VoIP packets, making it possible to level bias in a traffic load.

The control unit 11 generates a random number r (0≦r≦1) (step S703). The generation method of the random number r is not particularly limited and any known random number generation method can be used.

The control unit 11 adds a fluctuation value r·ΔT of the transmission interval to the transmission interval Ts and thereby obtains a new transmission interval Ts' (step S704). The control unit 11 determines whether the transmission interval Ts' has elapsed (step S705). If the control unit 11 determines that the transmission interval Ts' has not elapsed (“NO” at step S705), the control unit 11 enters and remains in a standby state until the transmission interval Ts' has elapsed. If the control unit 11 determines that the transmission interval Ts' has elapsed (“YES” at step S705), the control unit 11 transmits a packet (step S706). After the control unit 11 transmits the packet, the control unit 11 determines whether the transmission of VoIP packets is completed (step S707).

If the control unit 11 determines that the transmission of the VoIP packets is not completed (“NO” at step S707), the control unit 11 returns the process to step S703 and repeats the process. If the control unit 11 determines that the transmission of the VoIP packets is completed (“YES” at step S707), the control unit 11 stops the transmission of the VoIP packets and ends the process.

As described above, according to the first embodiment, by the transmission interval of VoIP packets randomly fluctuating, the distribution of a traffic load is leveled and thus packet loss is reduced and the occurrence of delay is reduced. Accordingly, transmission quality difference caused by different transmission timing can be reduced, making it possible to improve the transmission quality.

### Second Embodiment

A packet communication system according a second embodiment of the present invention will be described below with reference to the drawings. The configuration of the packet communication system according to the second embodiment is the same as that of the first embodiment and thus the same reference numerals are used and the detailed description thereof is omitted. The second embodiment is different from the first embodiment in that a load detection packet is transmitted to grasp density distribution of a traffic load of the communication network 3 and transmission start timing is set such that a packet is transmitted at transmission timing with a low traffic load. Note that in the second embodiment too, as with the first embodiment, the period of bias in the traffic load, i.e., the transmission interval Ts of VoIP packets, is 20 milliseconds.

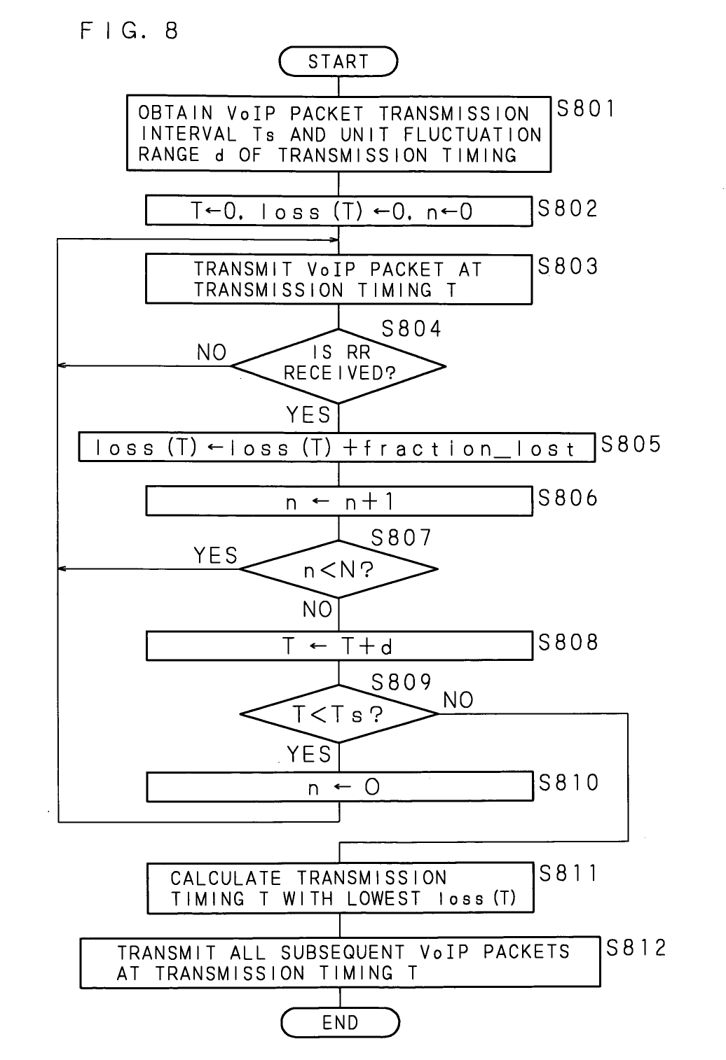

FIG. 8 is a flowchart showing steps of a VoIP packet transmission process of the control unit 11 of the transmission apparatus 1 used in the packet communication system according to the second embodiment of the present invention. In FIG. 8, a method of identifying transmission timing with low traffic load density based on load detection packet loss information is described. Note that the determination of traffic load density is not limited to one based on the load detection packet loss information; needless to say, even when a determination method based on VoIP packet delay information is used, the same processing steps are performed.

The control unit 11 of the transmission apparatus 1 obtains a transmission interval Ts of VoIP packets and a unit fluctuation range d of transmission timing (step S801). The transmission interval Ts of the VoIP packets and the unit fluctuation range d of the transmission timing may be received through the input unit 17 of the transmission apparatus 1 or may be received from an external apparatus through the communication unit 15. The unit fluctuation range d of the transmission timing is set to a value smaller than the transmission interval Ts of the VoIP packets.

The control unit 11 sets a correction fluctuation range T of the transmission timing, the number of packets lost (loss (T)) per transmission timing, and the number n of RTCP (RTP Control Protocol) RR (Receiver Report) packets received which are received as transmission quality information which indicates transmission quality, to initial values “0” (step S802). Note that the maximum value N of the number of RTCP (RTP Control Protocol) RR (Receiver Report) packets received is set to a predetermined value, for example, N=5.

The control unit 11 transmits a single load detection VoIP packet at transmission timing T (step S803) and determines whether an RTCP RR packet is received (step S804). Here, the transmission of the VoIP packet at the transmission timing T is meant to transmit the VoIP packet after the time T has elapsed from the time at which the VoIP packet should originally be transmitted. If the control unit 11 determines that the RR is not received (“NO” at step S804), the control unit 11 returns the process to step S803. If the control unit 11 determines that the RR packet is received (“YES” at step S804), the control unit 11 extracts the value of a header item “fraction_lost” of the RR packet and accumulates the extracted value in the number of packets lost (loss (T)) per transmission timing (step S805). That is, transmission timing with a large loss (T) value can be determined to have high communication traffic and high traffic load density, and transmission timing with a small loss (T) value can be determined to have low communication traffic and low traffic load density.

The control unit 11 increments the number n of RR packets received by one (step S806) and determines whether the number n is smaller than the maximum value N of the number of RR packets received, for example, five (step S807). If the control unit 11 determines that the number n is smaller than the maximum value N of the number of RR packets received (“YES” at step S807), the control unit 11 returns the process to step S803 and repeats the process.

If the control unit 11 determines that the number n is greater than the maximum value N of the number of RR packets received (“NO” at step S807), the control unit 11 increments the transmission timing T by the unit fluctuation range d of the transmission timing (step S808) and determines whether the calculated transmission timing T is smaller than the transmission interval Ts of the VoIP packets (step S809). If the control unit 11 determines that the calculated transmission timing T is smaller than the transmission interval Ts of the VoIP packets (“YES” at step S809), the control unit 11 sets the number n of RR packets received to an initial value “0” (step S810), returns the process to step S803, and repeats the process.

If the control unit 11 determines that the calculated transmission timing T is greater than the transmission interval Ts of the VoIP packets (“NO” at step S809), the control unit 11 calculates transmission timing T at which the number of packets lost (loss (T)) per transmission timing is lowest (step S811). Thereafter, a VoIP packet is continuously transmitted at the calculated transmission timing T (step S812).

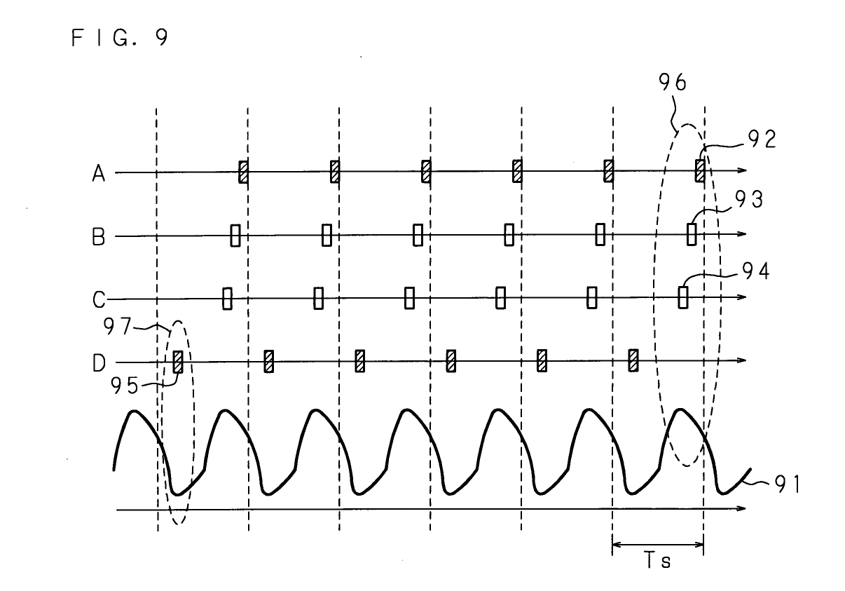

FIG. 9 is a diagram showing packet transmission timing in a packet communication method according to the second embodiment of the present invention. For example, in the second embodiment too, periodic bias is present in a traffic load 91. The period of bias in the traffic load 91 is equal to a transmission interval Ts of VoIP packets, for example, 20 milliseconds.

Under this condition, in calls A, B, and C, for example, VoIP packets (audio packets) 92, 93, and 94 are always transmitted at the second half part of the transmission interval Ts of the VoIP packets. Since in the calls A, B, and C the VoIP packets 92, 93, and 94 are transmitted at transmission timing 96 with high communication traffic, it is highly possible that the VoIP packets are delayed or the VoIP packets are lost, resulting in degradation of transmission quality.

When it is grasped by using a load detection VoIP packet that transmission timing 97 has low communication traffic, the transmission apparatus 1 sets transmission timing such that a VoIP packet 95 is transmitted at the transmission timing 97. Thus, the delay of a VoIP packet or the loss of the VoIP packet is less likely to occur, making it possible to maintain the transmission quality at a high level.

As described above, according to the second embodiment, by the transmission apparatus 1 transmitting a load detection VoIP packet, density distribution of a traffic load in a predetermined transmission interval, e.g., the transmission interval of VoIP packets, can be calculated. Then, by setting transmission timing such that a VoIP packet is transmitted at timing with low traffic load density, transmission quality can be maintained at a high level.

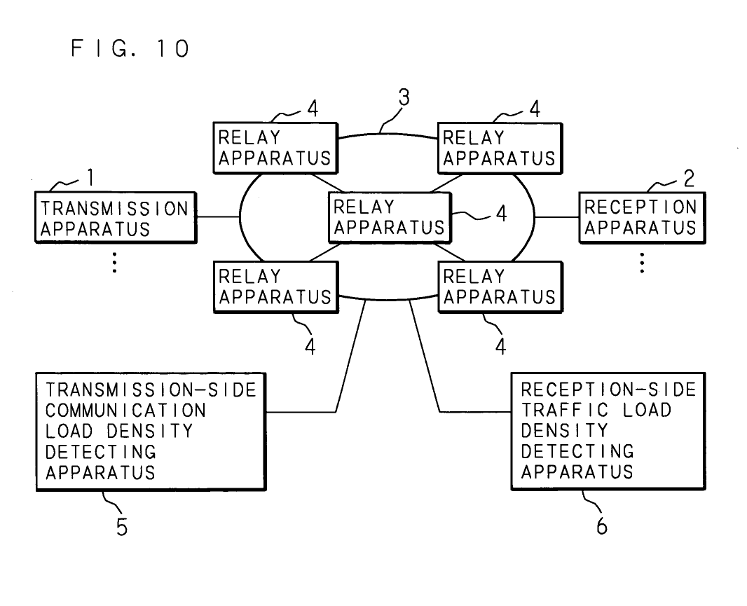

The configuration is not limited to the one in which a load detection VoIP packet is transmitted from the transmission apparatus 1 to calculate optimal transmission timing. For example, a traffic load density detecting apparatus that detects traffic load density may be separately provided and by obtaining a detection result by the traffic load density detecting apparatus, the transmission timing of VoIP packets may be changed. FIG. 10 is a block diagram showing a configuration of a packet communication system in which traffic load density detecting apparatuses are separately provided. In FIG. 10, the transmission apparatus 1 is connected to the communication network 3, such as the Internet, and transmits a packet to the reception apparatus 2 which is connected to the communication network 3 as well. To the communication network 3, are connected a plurality of the transmission apparatuses 1, 1 . . . which use computers that distribute stream data such as moving images and audio, and a plurality of the reception apparatuses 2, 2 . . . that receive the stream data transmitted from the transmission apparatuses 1, 1 . . . .

The communication network 3 has a plurality of relay apparatuses 4, 4 . . . such as Internet routers. Packets are transmitted to the reception apparatuses 2, 2 . . . from the transmission apparatuses 1, 1 . . . through communication paths composed of unspecified relay apparatuses 4, 4 . . . .

In addition, a transmission-side traffic load density detecting apparatus 5 is also connected to the communication network 3, such as the Internet, and transmits a VoIP packet to a reception-side traffic load density detecting apparatus 6 which is connected to the communication network 3 as well. The transmitted VoIP packet is transmitted to the reception-side traffic load density detecting apparatus 6 from the transmission-side traffic load density detecting apparatus 5 through a communication path composed of unspecified relay apparatuses 4, 4 . . . .

Traffic load density detecting apparatuses may be individually provided for the transmission side and the reception side, as shown in FIG. 10. Alternatively, an integral-type traffic load density detecting apparatus having a transmission port and a reception port in a single enclosure may be used. Steps of a calculation process of optimal transmission timing T in a traffic load density detecting apparatus are the same as steps S801 through S810 of the processing steps of the transmission apparatus 1 shown in FIG. 8, and thus, the detailed description thereof is omitted. The transmission apparatus 1 obtains optimal transmission timing T from a traffic load density detecting apparatus and transmits a VoIP packet at the obtained transmission timing T, thereby obtaining the same advantageous effects.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A packet communication system comprising a transmission apparatus that establishes a connection to a communication network to transmit a packet, wherein
the transmission apparatus comprises:
random number generating means for generating a random number; and
interval setting means for setting a packet transmission interval based on the generated random number, in which
the packet is transmitted in the packet transmission interval.

2. The packet communication system according to claim 1, wherein the interval setting means sets the transmission interval so as to be smaller than an upper limit of a ratio of the transmission interval.

3. A packet communication system comprising a transmission apparatus that establishes a connection to a communication network to transmit a packet; and
a reception apparatus that establishes a connection to the communication network to receive the packet, wherein
the transmission apparatus comprises:
means for calculating, based on transmission quality information about transmission quality which is returned in response to the transmitted packet, timing at which delay is smallest in a packet transmission interval and/or timing at which a loss rate is lowest in the packet transmission interval;
transmission start time setting means for setting a packet transmission start time with the calculated timing; and
means for starting packet transmission at the packet transmission start time.

4. The packet communication system according to claim 3, wherein
the reception apparatus comprises:
means for returning, in case that received a packet, the transmission quality information about the packet to the transmission apparatus, as a response.

5. A packet communication system comprising:
a transmission apparatus that establishes a connection to a communication network to transmit a packet; and
a traffic load density detecting apparatus that establishes a connection to the communication network to transmit and receive a load density detection packet for detecting traffic load density, thereby detecting the traffic load density, wherein
the transmission apparatus comprises:
means for receiving from the traffic load density detecting apparatus transmission quality information which includes timing at which delay is smallest based on the detected load density and/or timing at which a loss rate is lowest based on the detected load density;
transmission start time setting means for setting a packet transmission start time with the received timing; and
means for starting packet transmission at the packet transmission start time.

6. A packet communication system comprising:
a transmission apparatus that establishes a connection to a communication network to transmit a packet, wherein
the transmission apparatus comprises a processor capable of performing the steps of:
generating a random number;
setting a packet transmission interval based on the generated random number; and
transmitting the packet in the packet transmission interval.

7. The packet communication system according to claim 6, wherein
the transmission apparatus comprises the processor further capable of performing a step of:
setting the transmission interval so as to be smaller than an upper limit of a ratio of the transmission interval.

8. A packet communication system comprising:
a transmission apparatus that establishes a connection to a communication network to transmit a packet; and
a reception apparatus that establishes a connection to the communication network to receive the packet, wherein
the transmission apparatus comprises a processor capable of performing the steps of:
calculating, based on transmission quality information about transmission quality which is returned in response to the transmitted packet, timing at which delay is smallest in a packet transmission interval and/or timing at which a loss rate is lowest in the packet transmission interval;
setting a packet transmission start time with the calculated timing; and
starting packet transmission at the packet transmission start time.

9. The packet communication system according to claim 8, wherein
the reception apparatus comprises the processor further capable of performing a step of:
in case that received a packet, returning the transmission quality information about the packet to the transmission apparatus, as a response.

10. A packet communication system comprising:
a transmission apparatus that establishes a connection to a communication network to transmit a packet; and
a traffic load density detecting apparatus that establishes a connection to the communication network to transmit and receive a load density detection packet for detecting traffic load density, thereby detecting the traffic load density, wherein
the transmission apparatus comprises a processor capable of performing the steps of:
receiving from the traffic load density detecting apparatus transmission quality information which includes timing at which delay is smallest based on the detected load density and/or timing at which a loss rate is lowest based on the detected load density;
setting a packet transmission start time with the received timing; and
starting packet transmission at the packet transmission start time.

11. A packet communication method using a transmission apparatus that establishes a connection to a communication network to transmit a packet, the method comprising the steps of:
generating a random number;
setting a packet transmission interval based on the generated random number; and
transmitting the packet in the packet transmission interval.

12. A packet communication method using a transmission apparatus that establishes a connection to a communication network to transmit a packet, and a reception apparatus that establishes a connection to the communication network to receive the packet, the method comprising the steps of:
calculating, based on transmission quality information about transmission quality which is returned in response to the transmitted packet, timing at which delay is smallest in a packet transmission interval and/or timing at which a loss rate is lowest in the packet transmission interval;
setting a packet transmission start time with the calculated timing; and
starting packet transmission at the packet transmission start time.

13. A transmission apparatus that establishes a connection to a communication network to transmit a packet, the transmission apparatus comprising:
random number generating means for generating a random number; and
interval setting means for setting a packet transmission interval based on the generated random number, wherein
the packet is transmitted in the packet transmission interval.

14. The transmission apparatus according to claim 13, comprising means for setting the transmission interval so as to be smaller than an upper limit of a ratio of the transmission interval.

15. A transmission apparatus that establishes a connection to a communication network to transmit a packet, the transmission apparatus comprising:
means for calculating, based on transmission quality information about transmission quality which is returned in response to the transmitted packet, timing at which delay is smallest in a packet transmission interval and/or timing at which a loss rate is lowest in the packet transmission interval;
transmission start time setting means for setting a packet transmission start time with the calculated timing; and
means for starting packet transmission at the packet transmission start time.

16. A transmission apparatus that establishes a connection to a communication network to transmit a packet, the transmission apparatus comprising a processor capable of performing the steps of:
generating a random number;
setting a packet transmission interval based on the generated random number; and
transmitting the packet in the packet transmission interval.

17. The transmission apparatus according to claim 13, comprising a processor capable of performing a step of:
setting the transmission interval so as to be smaller than an upper limit of a ratio of the transmission interval.

18. A transmission apparatus that establishes a connection to a communication network to transmit a packet, the transmission apparatus comprising a processor capable of performing the steps of:
calculating, based on transmission quality information about transmission quality which is returned in response to the transmitted packet, timing at which delay is smallest in a packet transmission interval and/or timing at which a loss rate is lowest in the packet transmission interval;
setting a packet transmission start time with the calculated timing; and
starting packet transmission at the packet transmission start time.

19. A computer memory product storing a computer program which is executed by a transmission apparatus that establishes a connection to a communication network to transmit a packet, wherein
the computer program comprises the steps of:
causing a computer to generate a random number;
causing the computer to set a packet transmission interval based on the generated random number, and
causing the computer to transmit the packet in the packet transmission interval.

20. A computer memory product storing a computer program which is executed by a transmission apparatus that establishes a connection to a communication network to transmit a packet, wherein
the computer program comprises the steps of:
causing a computer to calculate, based on transmission quality information about transmission quality which is returned in response to the transmitted packet, timing at which delay is smallest in a packet transmission interval and/or timing at which a loss rate is lowest in the packet transmission interval;
causing the computer to set a packet transmission start time with the calculated timing; and
causing the computer to start packet transmission at the packet transmission start time.
